(19) United States
(12) Patent Application Publication
(10) Pub. No.: US 2024/0374050 A1
(43) Pub. Date: Nov. 14, 2024

(54) COLLAPSIBLE AND COMPACT CRIB INCLUDING ANGLED JOINTS

(71) Applicant: Guava Family, Inc., Solana Beach, CA (US)

(72) Inventors: Asa Giffin, Solana Beach, CA (US); Scott Crumrine, Solana Beach, CA (US)

(21) Appl. No.: 18/659,653

(22) Filed: May 9, 2024

Related U.S. Application Data
(60) Provisional application No. 63/466,166, filed on May 12, 2023.

(51) Int. Cl. A47D 9/00; A01K 1/035

(52) U.S. Cl. CPC A47D 9/005; A01K 1/035

(57) ABSTRACT

A collapsible frame is configured to transition between a collapsed position and an expanded position. A continuous rail includes a first corner joint with a first corner hinge with a first axis of rotation. A second corner joint includes a second corner hinge with a second axis of rotation. A first rigid rail is between the first corner joint and the second corner joint. A fourth corner joint includes a fourth corner hinge with a fourth axis of rotation. A third corner joint includes a third corner hinge with a fourth axis of rotation. A second rigid rail is between the third corner joint and the fourth corner joint. The second axis of rotation and the fourth axis of rotation are arranged such that the second segmented rail collapses at an angle sufficient to prevent interference with the first segmented rail when the collapsible frame is in the collapsed position.

### CROSS-REFERENCE TO RELATED APPLICATIONS

This application claims benefit of priority to U.S. Provisional Application No. 63/466,166, filed 12 May 2023, the contents of which is hereby incorporated by reference in its entirety.

### TECHNICAL FIELD

The subject matter described herein relates to devices and methods related to a collapsible device having a collapsible frame body that can adapt at least one of a flexible material component and an adaptable feature for a variety of uses, including providing at least partial containment.

### BACKGROUND

A standard infant bed, or crib, can provide a safe and secure sleeping area for a child. However, standard infant beds can be large and difficult to transport. In addition, it is common for children to want or need to sleep while away from the home where the infant bed is stored. As such, parents of children may find it difficult to provide a safe and secure sleeping area for their child when away from the home.

### SUMMARY

This disclosure relates to a collapsible and compact crib including angled joints.

An example implementation of the subject matter described within this disclosure is a collapsible frame configured to transition between a collapsed position and an expanded position. The collapsible frame includes the following features. A continuous rail includes a first corner joint with a first corner hinge with a first axis of rotation. A second corner joint includes a second corner hinge with a second axis of rotation. A first rigid rail is between the first corner joint and the second corner joint. The first corner joint and the second corner joint are at opposing ends of the first rigid rail. The first rigid rail extends along a first longitudinal axis. A third corner joint includes a third corner hinge with a third axis of rotation. A fourth corner joint includes a fourth corner hinge with a fourth axis of rotation. A second rigid rail is between the third corner joint and the fourth corner joint. The third corner joint and the fourth corner joint are at opposing ends of the second rigid rail. The second rigid rail extends along a second longitudinal axis the first longitudinal axis and the second longitudinal axis extending approximately parallel to a first plane when the collapsible frame is in the expanded position. A first segmented rail includes a first linear joint. The first segmented rail is between the first corner joint and the third corner joint. The first linear joint includes a first linear hinge comprising a fifth axis of rotation. The fifth axis of rotation extends substantially normal to the first plane when in the expanded position. A second segmented rail includes a second linear joint. The second segmented rail is between the second corner joint and the fourth corner joint. The second linear joint includes a second linear hinge with a sixth axis of rotation. The sixth axis of rotation extends substantially normal to the first plane when in the expanded position. The second axis of rotation and the fourth axis of rotation are arranged such that the second segmented rail collapses at an angle sufficient to prevent interference with the first segmented rail when the collapsible frame is in the collapsed position.

Aspects of the example collapsible frame configured to transition between a collapsed position and an expanded position, which can be combined with the example collapsible frame configured to transition between a collapsed position and an expanded position alone or in combination with other aspects, include the following. The first rigid rail and the second rigid rail are parallel to one another and the first plane when the collapsible frame is in the collapsed position and when the collapsible frame is in the expanded position.

Aspects of the example collapsible frame configured to transition between a collapsed position and an expanded position, which can be combined with the example collapsible frame configured to transition between a collapsed position and an expanded position alone or in combination with other aspects, include the following. The angle to sufficiently to prevent interference is measured relative to the first plane when the collapsible frame is in the collapsed position.

Aspects of the example collapsible frame configured to transition between a collapsed position and an expanded position, which can be combined with the example collapsible frame configured to transition between a collapsed position and an expanded position alone or in combination with other aspects, include the following. The angle is a negative angle relative to the plane.

Aspects of the example collapsible frame configured to transition between a collapsed position and an expanded position, which can be combined with the example collapsible frame configured to transition between a collapsed position and an expanded position alone or in combination with other aspects, include the following. The first segmented rail has an angle ranging 0° and 5° relative to the first plane when the collapsible frame is in the collapsed position.

Aspects of the example collapsible frame configured to transition between a collapsed position and an expanded position, which can be combined with the example collapsible frame configured to transition between a collapsed position and an expanded position alone or in combination with other aspects, include the following. None of the first axis of rotation, the second axis of rotation, the third axis of rotation, or the fourth axis of rotation are parallel to one another or a frame longitudinal axis that extends transverse to the first plane when the collapsible frame is in the expanded position and in the collapsed position.

Aspects of the example collapsible frame configured to transition between a collapsed position and an expanded position, which can be combined with the example collapsible frame configured to transition between a collapsed position and an expanded position alone or in combination with other aspects, include the following. The fifth axis of rotation and the sixth axis of rotation are substantially parallel with one another when the collapsible frame is in the expanded position and are not parallel with one another when the collapsible frame is in the collapsed position.

Aspects of the example collapsible frame configured to transition between a collapsed position and an expanded position, which can be combined with the example collapsible frame configured to transition between a collapsed position and an expanded position alone or in combination with other aspects, include the following. The continuous rail is rectangular in shape with opposing first and second rigid rails and opposing first and second segment rails with the first and second segmented rails having a length that is longer than the first and second rigid rails.

Aspects of the example collapsible frame configured to transition between a collapsed position and an expanded position, which can be combined with the example collapsible frame configured to transition between a collapsed position and an expanded position alone or in combination with other aspects, include the following. The first linear hinge includes a lockable hinge configured to be activated by a user and allow the user to lock and unlock the first linear joint.

Aspects of the example collapsible frame configured to transition between a collapsed position and an expanded position, which can be combined with the example collapsible frame configured to transition between a collapsed position and an expanded position alone or in combination with other aspects, include the following. The collapsible frame includes collapsible legs.

Aspects of the example collapsible frame configured to transition between a collapsed position and an expanded position, which can be combined with the example collapsible frame configured to transition between a collapsed position and an expanded position alone or in combination with other aspects, include the following. Each of the collapsible legs includes the following features. A first end is attached to the continuous rail. A second end is configured to rest upon a surface. A linear leg joint is between the first end and the second end.

Aspects of the example collapsible frame configured to transition between a collapsed position and an expanded position, which can be combined with the example collapsible frame configured to transition between a collapsed position and an expanded position alone or in combination with other aspects, include the following. The collapsible legs include four collapsible legs.

Aspects of the example collapsible frame configured to transition between a collapsed position and an expanded position, which can be combined with the example collapsible frame configured to transition between a collapsed position and an expanded position alone or in combination with other aspects, include the following. Each of the collapsible legs is attached to the first rigid rail or the second rigid rail.

Aspects of the example collapsible frame configured to transition between a collapsed position and an expanded position, which can be combined with the example collapsible frame configured to transition between a collapsed position and an expanded position alone or in combination with other aspects, include the following. A flexible material component is configured to reversibly secure to at least a part of the collapsible frame and provide at least partial containment. A foldable base is configured to reversibly mate with the flexible material.

An example implementation of the subject matter described herein is a method with the following features. Each one of a multitude of legs is folded by a respective leg joint of each of the multitude of legs. A continuous rail is folded by four corner joints and two linear joints. A first linear joint folds at an angle such that the first linear joint avoids an interference with a second linear joint.

Aspects of the example method, which can be combined with the example method alone or in combination with other aspects, include the following. Folding each of the plurality of legs includes releasing a joint lock by a pressed button.

Aspects of the example method, which can be combined with the example method alone or in combination with other aspects, include the following. Folding the continuous rail includes releasing the first linear joint by a pressed first button and releasing the second linear joint by a pressed second button.

Aspects of the example method, which can be combined with the example method alone or in combination with other aspects, include the following. a flexible material component is removed prior to folding the continuous rail. The flexible material component is configured to reversibly secure to at least a part of the continuous rail.

An example implementation of the subject matter described within this disclosure is a collapsible device configured to transition between a collapsed position and an expanded position. The collapsible device includes the following features. A continuous rail includes a first corner joint having a first corner hinge with a first axis of rotation. A second corner joint includes a second corner hinge with a second axis of rotation. A first rigid rail is between the first corner joint and the second corner joint. The first corner joint and the second corner joint are at opposing ends of the first rigid rail. A third corner joint includes a third corner hinge with a third axis of rotation. A fourth corner joint includes a fourth corner hinge with a fourth axis of rotation. A second rigid rail between the third corner joint and the fourth corner joint. The third corner joint and the fourth corner joint are at opposing ends of the second rigid rail. The second rigid rail is opposite the first rigid rail. A first segmented rail includes a first linear joint. The first segmented rail is between the first corner joint and the third corner joint. The first linear joint includes a lockable linear hinge with a fifth axis of rotation. The fifth axis of rotation is substantially aligned with an outer surface of the first segmented rail. The first axis of rotation and the third axis of rotation are arranged such that the first segmented rail is substantially parallel to the first rigid rail and the second rigid rail when the collapsible device is in the collapsed position. A second segmented rail includes a second linear joint. The second segmented rail is between the second corner joint and the fourth corner joint. The second linear joint includes a second lockable linear hinge comprising a sixth axis of rotation. The sixth axis of rotation is substantially aligned with an outer surface of the second segmented rail. The second axis of rotation and the fourth axis of rotation are arranged such that the second segmented rail collapses at an angle sufficient to prevent interference with the first segmented rail when the collapsible device is in the collapsed position. A flexible material component is configured to reversibly secure to at least a part of the collapsible device and provide the least partial containment. A foldable base is configured to reversibly mate with the flexible material.

Aspects of the example collapsible device, which can be combined alone or in combination with other aspects, include the following. None of the first axis of rotation, the second axis or rotation, the third axis of rotation, and the fourth axis of rotation are parallel to one another.

Aspects of the example collapsible device, which can be combined alone or in combination with other aspects, include the following. The fifth axis of rotation and the sixth axis or rotation are substantially vertical and parallel with one another when the collapsible device is in the expanded position.

Aspects of the example collapsible device, which can be combined alone or in combination with other aspects, include the following. The continuous rail is rectangular in shape with opposing first and second rigid rails and opposing first and second segment rails with the first and second segmented rails having a length that is longer than the first and second rigid rails.

Aspects of the example collapsible device, which can be combined alone or in combination with other aspects, include the following. The second segmented rail includes a locking mechanism configured to be activated by a user and allow the user to lock and unlock the second linear joint.

Aspects of the example collapsible device, which can be combined alone or in combination with other aspects, include the following. The collapsible device includes multiple collapsible legs.

Aspects of the example collapsible device, which can be combined alone or in combination with other aspects, include the following. Each of the collapsible legs includes a first end attached to the continuous rail and a second end configured to rest upon a surface. A linear leg joint is between the first end and the second end.

Aspects of the example collapsible device, which can be combined alone or in combination with other aspects, include the following. The collapsible legs include four collapsible legs.

Aspects of the example collapsible device, which can be combined alone or in combination with other aspects, include the following. One of the collapsible legs is attached to the first rigid rail or the second rigid rail.

### BRIEF DESCRIPTION OF DRAWINGS

FIG. 1 an example collapsible frame in an expanded position.

FIG. 2 is a perspective view of the example collapsible frame with a flexible material attached.

FIG. 3 is a side view of a leg of the example collapsible frame.

FIG. 4 illustrates the example collapsible frame in a partially collapsed position.

FIG. 5 illustrates the example collapsible frame in a fully collapsed position.

FIG. 6 is a flowchart of an example method that can be used with aspects of this disclosure.

Like reference symbols in the various drawings indicate like elements.

### DETAILED DESCRIPTION

This disclosure describes a collapsible device which can provide at least partial containment for one or more objects, including a child or animal, and which can collapse or fold into a compact configuration in order to allow for improved portability of the collapsible device. In some implementations of the present subject matter, the collapsible device can include a collapsible frame and at least one flexible material component that can be reversibly secured to the collapsible frame and can assist in providing partial containment or enclosure. In addition, some implementations of the present subject matter can include a foldable or collapsible base which can provide a support along at least one side of the containment provided by the collapsible device.

In some implementations of the present subject matter, the collapsible frame can be configured to allow a variety of adaptable elements to be adapted to the collapsible frame. For example, the collapsible frame can include one or more legs or extensions which can be configured to permanently or reversibly adapt one or more adaptable features, such as rocker adapters or various foot adapters, which can allow the collapsible device to have a variety of functions and characteristics, as will be discussed in greater detail below.

In addition, some implementations of collapsible device can include one or more joints or hinges that can allow the collapsible device to configure into a variety of configurations, including expanded and collapsed configurations. Additionally, the joints can have a variety of ranges of motion, including some joints with restricted or limited ranges of motions. Furthermore, one or more joints can include a locking feature, such as a user-activated locking feature, which can allow a user to lock the locking feature such that the corresponding joint has no range of motion or unlock the locking feature such that the corresponding joint has a defined or variable range of motion.

The collapsible device disclosed herein can be used for a variety of containment purposes, such as for a baby bed or crib, a bassinet, a dog kennel, or the like. In addition, some implementations of the collapsible device can be used for non-containment purposes, including a platform for other products such as a portable table or other type of platform. However, it has been contemplated that the collapsible device can be used for a variety of uses and is not limited to the examples provided herein.

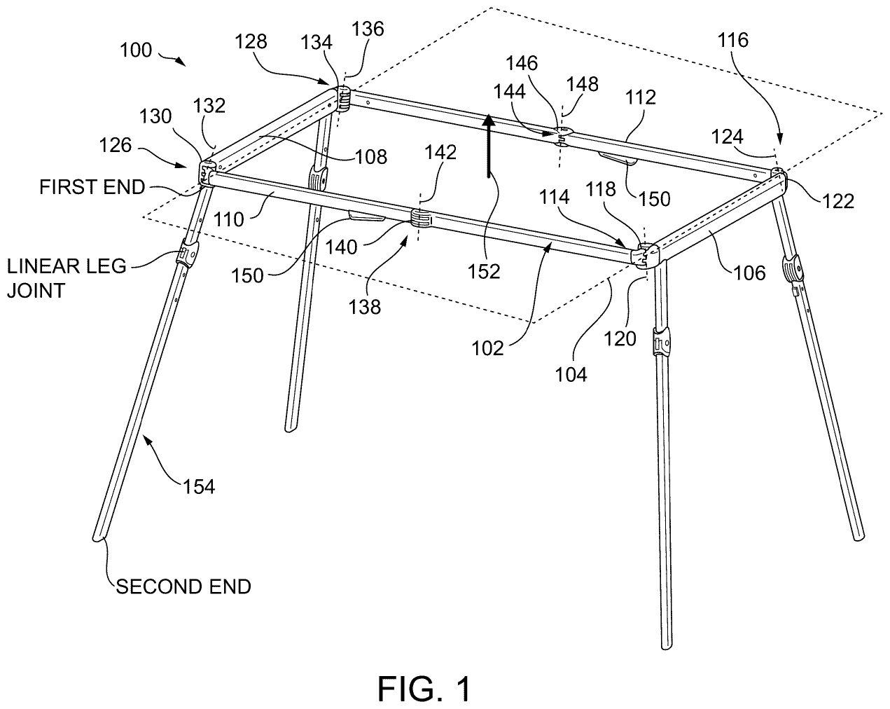

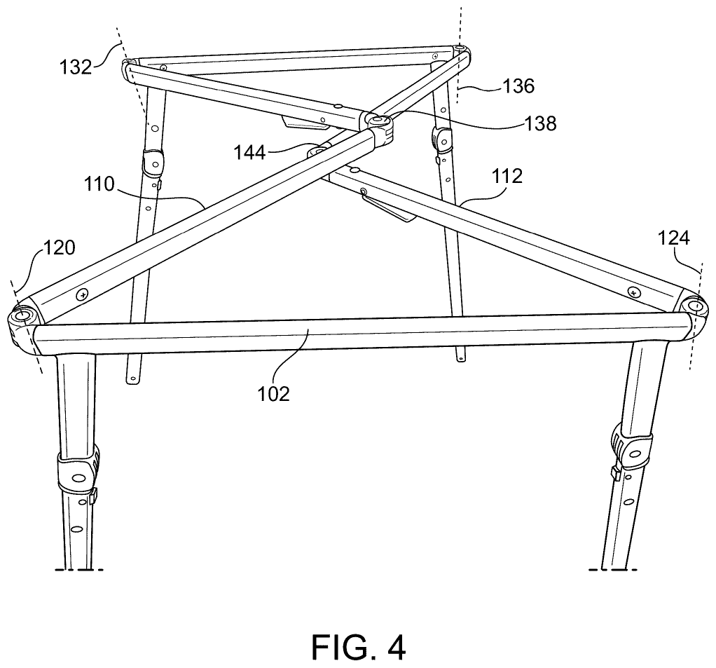

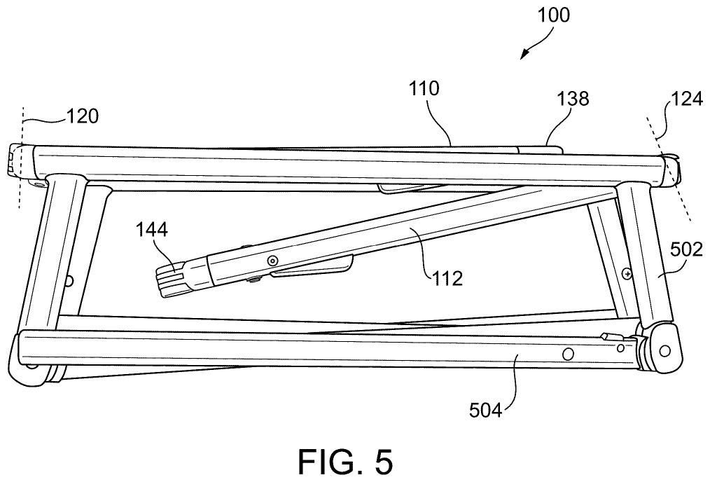

FIG. 1 illustrates an example collapsible frame 100 in an expanded position. The collapsible frame 100 is configured to transition between a collapsed position (FIG. 5) and an expanded position (FIG. 1). An upper portion of the collapsible frame 100 can include a continuous rail 102. The continuous rail 102 defines a plane 104 when the collapsible frame 100 is in the expanded position. As illustrated, the continuous rail 102 is rectangular in shape with an opposing first rigid rail 106 extending along a first longitudinal axis and second rigid rail 108 extending along a second longitudinal axis. Similarly, a first segmented rail 110 and a second segmented rail 112 oppose one another. In some implementations, the opposing first rigid rail 106 (including first longitudinal axis) and the second rigid rail 108 (including the second longitudinal axis) extend substantially parallel to each other and/or extend along the plane 104 when the collapsible frame 100 is in the expanded position and/or the collapsed position. In some implementations, the first segmented rail 110 and the second segmented rail 112 extend substantially parallel to each other and/or extend along the plane 104 when the collapsible frame 100 is in the expanded position. However, when in the collapsed position, the first segmented rail 110 or the second segmented rail 112 extend away from the plane 104 and/or the first segmented rail 110 and the second segmented rail 112 extend along different, non-coplanar planes. This allows the continuous rail 102 to form a compact collapsed position, as shown in FIG. 4, by allowing the first segmented rail 110 and the second segmented rail 112 to collapse and bend without intersecting each other. For example, the first segmented rail 110 can transition from the extended position to the collapsed position along a first segmented rail plane that is coplanar with the plane 104, and the second segmented rail 112 can transition from the extended position to the collapsed position along a second segmented rail plane that is non-coplanar with the plane 104 and/or the first segmented rail plane. For example, the first segmented rail 110 can form the collapsed position along the plane 104 and maintain being approximately parallel with the opposing first rigid rail 106 and the opposing second rigid rail 108, however, the second segmented rail 112 can form the collapsed position such that the second segmented rail 112 is angled away from the plane 104. In some implementations, the first segmented rail 110 and the second segmented rail 112 have a length that is longer than the first rigid rail 106 and/or the second rigid rail 108.

Each of the segmented rails (110, 112) and rigid rails (106, 108) is separated from an adjacent rail by a corner joint (114, 116, 126, 128). For example, the first rigid rail 106 is between a first corner joint 114 and the second corner joint 116. In other words, the first corner joint 114 and the second corner joint 116 are at opposing ends of the first rigid rail 106. The first corner joint 114 has a first hinge 118 with a first axis of rotation 120, and the second corner joint 116 has a second hinge 122 with a second axis of rotation 124.

Similarly, the second rigid rail 108 is between the third corner joint 126 and the fourth corner joint 128. In other words, the third corner joint 126 and the fourth corner joint 128 are at opposing ends of the second rigid rail 108. The third corner joint 126 has a third hinge 130 with a third axis of rotation 132, and the fourth corner joint 128 has a fourth hinge 134 with a fourth axis of rotation 136.

The first segmented rail 110 is between the first corner joint 114 and the third corner joint 126. The first segmented rail 110 includes a first linear joint 138. The first linear joint 138 has a first linear hinge 140 with a fifth axis of rotation 142. The fifth axis of rotation 142 extends substantially (within standard manufacturing tolerances) normal to the plane 104 when the collapsible frame 100 is in the expanded position.

The second segmented rail 112 has a second linear joint 144. The second segmented rail 112 is between the second corner joint 116 and the fourth corner joint 128. The second linear joint 144 includes a second linear hinge 146 with a sixth axis of rotation. The sixth axis of rotation 148 extends substantially normal to the plane 104 when in the collapsible frame 100 is in the expanded position. In some implementations, the first segmented rail 110, the second segmented rail 112, or both, include a locking mechanism 150 configured to be activated by a user. Such a mechanism allows a user to lock and unlock the first linear joint 138 or the second linear joint 144 respectively. Any one or more of the axis of rotations associated with a joint or hinge can be angled relative to one or more other axis of rotations associated with another joint or hinge, and/or angled relative to the frame longitudinal axis 152. For example, the fifth axis of rotation 142 and the sixth axis or rotation 148 can be angled relative to each other, which can assist with ensuring the first segmented rail 110 and the second segmented rail 112 are not parallel with one another when the collapsible frame 100 is in the collapsed position.

The first axis of rotation 120, the second axis of rotation 124, the third axis of rotation 132, and the fourth axis of rotation 136 in part define a transition between the collapsed position and the expanded position. In some implementations, the first axis of rotation 120, the second axis of rotation 124, the third axis of rotation 132, and the fourth axis of rotation 136 are angled relative to each other and a frame longitudinal axis 152 that extends transverse, or perpendicular, to the plane 104. The varying angles allow for a more compact collapsed position, including allowing the segmented rails (110, 112) to pivot towards the frame longitudinal axis 152 when forming the collapsed position.

The collapsible frame includes one or more collapsible legs 154. In the illustrated implementation, four legs 154 are included; however, greater or fewer legs can be included without departing from this disclosure. For example, three legs, five legs, or six legs can be included. In the illustrated implementation, each of the collapsible legs 154 is attached to the first rigid rail 106 or the second rigid rail 108; however, legs 154 can be attached to one of the segmented rails (110, 112) without departing from this disclosure. More details on the collapsible legs 154 are described throughout this disclosure.

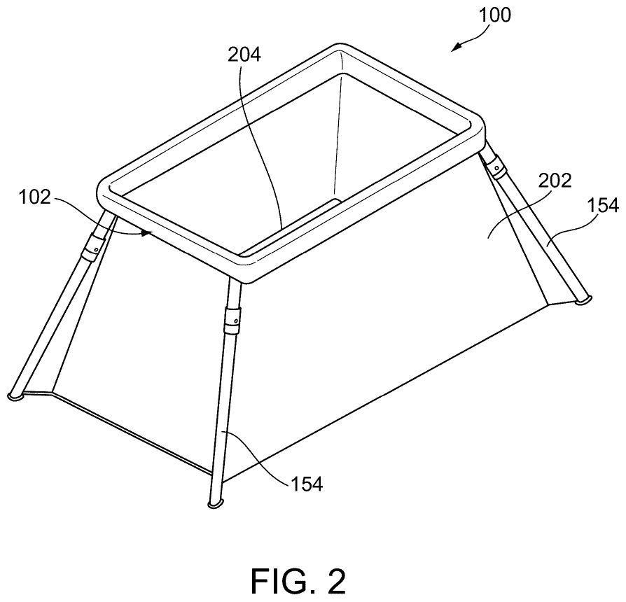

FIG. 2 is a perspective view of the example collapsible frame 100 with a flexible material component 202 attached, such as to form an implementation of a crib. The flexible material component 202 can have a variety of shapes and sizes and can permanently or reversibly secure to the collapsible frame 100 in a variety of ways. In addition, the flexible material component 202 can be made out of one or more of a variety of materials, including nylon, polyester, cotton, any of a variety of synthetic or natural textile or mesh fabric, or an assembly of multiple textile types.

For example, the flexible material component 202 can be shaped and sized to secure to the collapsible frame 100 and form at least a partial enclosure or containment area, such as for a child or animal. In addition, the containment area can include a foldable base 204, the bottom of which can rest on the ground. The foldable base 204 can be connected to a mostly vertical mesh perimeter that rises up from the foldable base 204 and extends to the continuous rail 102 of the collapsible frame 100. The combination of the base 204 and the mostly vertical mesh perimeter can create a containment area, such as for the child.

For example, the flexible material component 202 can assemble to the continuous rail 102 by securing one or more securing elements, such as a zipper, around at least a part of the continuous rail 102. However, any number of a variety of securing elements, including snap-buttons, hook and loop fasteners, or the like can be used.

In addition, at least a part of the flexible material component 202, such as the vertical mesh perimeter, can secure to one or more legs 154. For example, one or more lower corners of the flexible material component 202 can have connectors that fasten to the base of one or more legs 154. The connectors can secure the flexible material component 202 to one or more legs 154 by, for example, securing or sliding up into the distal end of the one or more legs 154. These connectors could also permanently or reversibly attach to the one or more legs 154 in a variety of ways. These connectors may also act as feet for the one or more legs 154.

In some implementations, the base 204 can include a mattress that can be constructed out of a padding material for comfort. For example, the mattress can be made out of a foam sheet of approximately 1 inch thick and can be approximately ¼ to 4 inches thick or more. In addition, the base 204 can include a rigid element which can be positioned during use under the mattress, such as for providing additional support for the mattress. At least one of the rigid element and mattress can have one or more creases or joints that can assist in collapsing or folding the rigid element and mattress, such as for allowing improved transport in a compact configuration (e.g., collapsed crib).

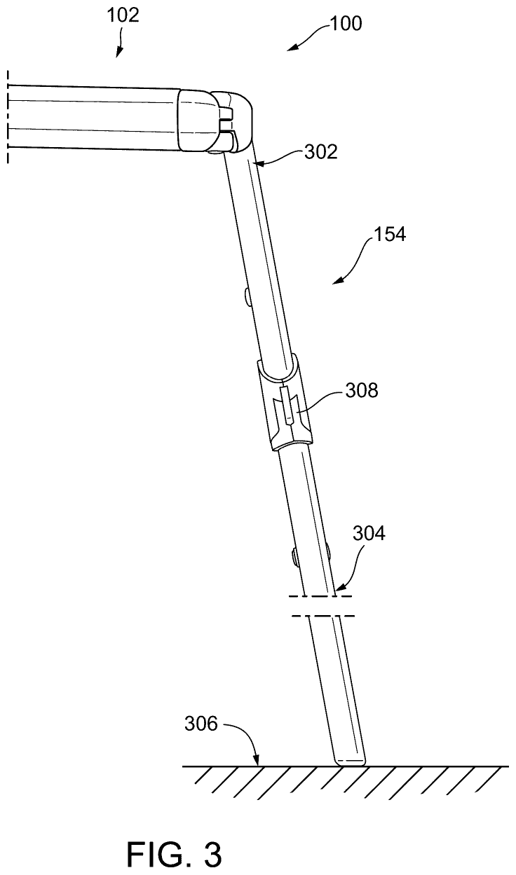

FIG. 3 is a side view of a leg 154 of the example collapsible frame 100. Each leg 154 has a first end 302 attached to the continuous rail 102 and a second end 304 configured to rest upon a surface 306. In some implementations, the leg 154 includes a leg linear leg joint 308. In some implementations, the linear leg joint 308 is closer to the first end 302 than the second end 304. That is, in some implementations, the linear leg joint is closer to the continuous rail than the surface 306. As previously described, each leg 154 is attached to one of the rigid rails (106, 108) in the illustrated examples; however, a leg can be attached to one of the segmented rails (110, 112) without departing from this disclosure. In some implementations, one or more of the legs 154 extends from the continuous rail 102 at an angle. Such an angle allows for a larger, more stable footprint of the collapsible frame 100. In the collapsed position, the legs can pivot towards the frame longitudinal axis 152 until the legs are approximately parallel to each other. This can allow for a more compact configuration of collapsed position of the collapsible frame 100.

FIG. 4 illustrates the example collapsible frame 100 in a partially collapsed position. As previously discussed, none of the first axis of rotation 120, the second axis or rotation 124, the third axis of rotation 132, nor the fourth axis of rotation 136 are parallel to one another. These various angles allow the segmented rails (110, 112) to collapse at different angles to one another, for example, angles that prevent the segmented rails (110, 112) from interfering with one another during collapsing operations. In the illustrated example, the second segmented rail 112 extends at an angle relative to the first segmented rail 110 during collapsing operations. In other words, the first segmented rail 110 can avoid contact with the second segmented rail 112 during collapsing operations. During collapsing operations, the first linear joint 138 and the second linear joint 144 fold towards the frame longitudinal axis 152 (FIG. 1).

FIG. 5 illustrates the example collapsible frame 100 in a fully collapsed position. As can be seen, the first linear joint 138 folds at an angle such that the first linear joint 138 avoids an interference with a second linear joint 144. Such an angle can be measured relative to the plane 104. For example, the angle can be a negative angle relative to the plane 104. Similarly, the segmented rails (110, 112) extend at an angle to one another to prevent any interference. Conversely, the first axis of rotation 120 and the third axis of rotation 132 (see FIG. 1) can be arranged such that the first segmented rail 110 is substantially parallel (e.g., within 5 degrees) to the first rigid rail 106 and the second rigid rail 108 when the collapsible frame is in the collapsed position. In some implementations, the first segmented rail 110 has an angle ranging 0° and 5° relative to the plane 104 and/or the first rigid rail 106 when the collapsible frame 100 is in the collapsed position. Alternatively or in addition, in some implementations, the first rigid rail 106 and the second rigid 108 rail are parallel to one another and the plane 104 when the collapsible frame 100 is in the collapsed position and when the collapsible frame 100 is in the expanded position. The first, second, third, and fourth axes of rotation can be arranged such that the first linear joint 138 and the first segmented rail 110 are non-coplanar with the second linear joint 144 and second segmented rail 112 in such a way that prevents interference between the segmented rails. Additionally, the segmented rails can fold toward each other, that is, not directly toward the ground, but instead at least partially toward the frame longitudinal axis 152 in the collapsed position. In some implementations, none of the first axis of rotation 122, the second axis of rotation 124, the third axis of rotation 132, or the fourth axis of rotation 136 are parallel to one another or the frame longitudinal axis 152 that extends transverse to the plane 104 when the collapsible frame 100 is in the expanded position and in the collapsed position.

In some embodiments, the legs 154 are also collapsed or folded in the collapsed position. Each leg hinge 308 divides each leg into a first portion 502 closer to the first end 302 and a second portion 504 closer to the second end. In some implementations, the second portion is substantially a similar length (e.g., within 10%) of the rigid rails (106, 108). The leg hinges 308 may be angled in such a way that, when the legs 154 are collapsed, the legs 154 avoid interference with one another. For example, the leg hinges 308 may be angled inwardly or outwardly such that a leg 154 does not interfere with an opposing leg 154 in the collapsed position. For example, the first portion 502 of each leg can extend at an angle relative to the frame longitudinal axis 152 when in the extended configuration and pivot towards the frame longitudinal axis 152 (e.g., become parallel with the frame longitudinal axis 152) when in the collapsed position. In some embodiments, the second portion 504 of two adjacent legs can extend approximately parallel and/or along a same or similar plane when in the extended configuration and pivot towards and offset from each other in order to arrange in a non-planar, side-by-by side compact formation, as shown in FIG. 5, when in the collapsed position.

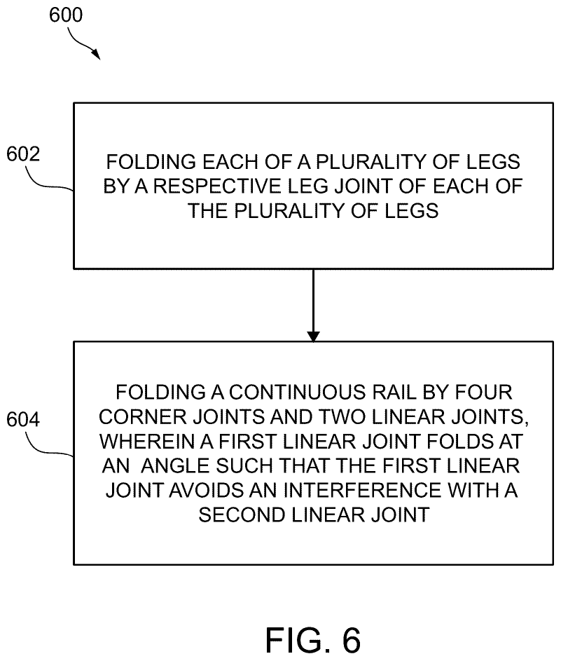

FIG. 6 is a flowchart of an example method 500 that can be used with aspects of this disclosure. At 602, each of the legs 154 is folded by a respective leg joint 308 of each of the legs 154. In some embodiments, folding each of the legs 154 includes releasing a joint lock by a pressed button.

At 604, the continuous rail 102 is folded by four corner joints and two linear joints. The first linear joint 138 folds at an angle such that the first linear joint 138 avoids an interference with a second linear joint 144. The second linear joint 144 folds at an angle such that the second linear joint 144 avoids an interference with the first linear joint 138 (e.g., the segmented rails (110, 112) collapse and fold toward the frame longitudinal axis at an angle relative to each other to thereby prevent intersection therebetween).

The first linear joint 138 and the second linear joint 144 can be configured such that in the collapsed configuration, one joint may be substantially positioned along the first plane and the other joint may be offset above or below in order to avoid interference. In some embodiments, both joints may be above or below the first plane and still avoid interference with each other. In some embodiments, folding the continuous rail 102 includes releasing the first linear joint 138 by a pressed first button and releasing the second linear joint 144 by a pressed second button.

In some embodiments, a flexible material component is removed prior to folding the continuous rail. In such embodiments, the flexible material component is configured to reversibly mate and/or secure to at least a part of the continuous rail, for example, with a hook and loop fastener, a snap button fastener, a zipper, or a button fastener.

While this disclosure contains many specific embodiment details, these should not be construed as limitations on the scope of what may be claimed, but rather as descriptions of features specific to particular embodiments. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

Other embodiments can be within the scope of the following claims.

What is claimed is:

1. A collapsible frame configured to transition between a collapsed position and an expanded position, the collapsible frame comprising:
a continuous rail comprising:
a first corner joint comprising a first corner hinge with a first axis of rotation;
a second corner joint comprising a second corner hinge with a second axis of rotation;
a first rigid rail between the first corner joint and the second corner joint, the first corner joint and the second corner joint being at opposing ends of the first rigid rail, the first rigid rail extending along a first longitudinal axis;
a third corner joint comprising a third corner hinge with a third axis of rotation;
a fourth corner joint comprising a fourth corner hinge with a fourth axis of rotation;
a second rigid rail between the third corner joint and the fourth corner joint, the third corner joint and the fourth corner joint being at opposing ends of the second rigid rail, the second rigid rail extending along a second longitudinal axis, the first longitudinal axis and the second longitudinal axis extending approximately parallel to a first plane when the collapsible frame is in the expanded position;
a first segmented rail comprising a first linear joint, the first segmented rail being between the first corner joint and the third corner joint, the first linear joint comprising a first linear hinge comprising a fifth axis of rotation, the fifth axis of rotation extending substantially normal to the first plane when in the expanded position; and
a second segmented rail comprising a second linear joint, the second segmented rail being between the second corner joint and the fourth corner joint, the second linear joint comprising a second linear hinge comprising a sixth axis of rotation, the sixth axis of rotation extending substantially normal to the first plane when in the expanded position, wherein the second axis of rotation and the fourth axis of rotation are arranged such that the second segmented rail collapses at an angle sufficient to prevent interference with the first segmented rail when the collapsible frame is in the collapsed position.

2. The collapsible frame of claim 1, wherein the first rigid rail and the second rigid rail are parallel to one another and the first plane when the collapsible frame is in the collapsed position and when the collapsible frame is in the expanded position.

3. The collapsible frame of claim 2, wherein the angle to sufficient to prevent interference is measured relative to the first plane when the collapsible frame is in the collapsed position.

4. The collapsible frame of claim 3, wherein the angle is a negative angle relative to the plane.

5. The collapsible frame of claim 2, wherein the first segmented rail has an angle ranging 0° and 5° relative to the first plane when the collapsible frame is in the collapsed position.

6. The collapsible frame of claim 1, wherein none of the first axis of rotation, the second axis of rotation, the third axis of rotation, or the fourth axis of rotation are parallel to one another or a frame longitudinal axis that extends transverse to the first plane when the collapsible frame is in the expanded position and in the collapsed position.

7. The collapsible frame of claim 1, wherein the fifth axis of rotation and the sixth axis of rotation are substantially parallel with one another when the collapsible frame is in the expanded position and are not parallel with one another when the collapsible frame is in the collapsed position.

8. The collapsible frame of claim 1, wherein the continuous rail is rectangular in shape with opposing first and second rigid rails and opposing first and second segment rails with the first and second segmented rails having a length that is longer than the first and second rigid rails.

9. The collapsible frame of claim 1, wherein the first linear hinge includes a lockable hinge configured to be activated by a user and allow the user to lock and unlock the first linear joint.

10. The collapsible frame of claim 1, further comprising a plurality of collapsible legs.

11. The collapsible frame of claim 10, wherein each of the collapsible legs comprise:
a first end attached to the continuous rail;
a second end configured to rest upon a surface; and
a linear leg joint between the first end and the second end.

12. The collapsible frame of claim 10, wherein the plurality of collapsible legs comprises four collapsible legs.

13. The collapsible frame of claim 10, wherein each of the collapsible legs is attached to the first rigid rail or the second rigid rail.

14. The collapsible frame of claim 1, further comprising:
a flexible material component configured to reversibly secure to at least a part of the collapsible frame and provide at least partial containment; and
a foldable base configured to reversibly mate with the flexible material.

15. A method comprising:
folding each of a plurality of legs by a respective leg joint of each of the plurality of legs; and
folding a continuous rail by four corner joints and two linear joints, wherein a first linear joint folds at an angle such that the first linear joint avoids an interference with a second linear joint.

16. The method of claim 15, wherein folding each of the plurality of legs further comprises:
releasing a joint lock by a pressed button.

17. The method of claim 15, wherein folding the continuous rail comprises:
releasing the first linear joint by a pressed first button; and
releasing the second linear joint by a pressed second button.

18. The method of claim 15, further comprising removing a flexible material component prior to folding the continuous rail, the flexible material component configured to reversibly secure to at least a part of the continuous rail.

19. A collapsible device configured to transition between a collapsed position and an expanded position, the collapsible device comprising:
a continuous rail comprising:
a first corner joint comprising a first corner hinge with a first axis of rotation;
a second corner joint comprising a second corner hinge with a second axis of rotation;
a first rigid rail between the first corner joint and the second corner joint, the first corner joint and the second corner joint being at opposing ends of the first rigid rail;
a third corner joint comprising a third corner hinge with a third axis of rotation;
a fourth corner joint comprising a fourth corner hinge with a fourth axis of rotation;
a second rigid rail between the third corner joint and the fourth corner joint, the third corner joint and the fourth corner joint being at opposing ends of the second rigid rail, the second rigid rail being opposite the first rigid rail;
a first segmented rail comprising a first linear joint, the first segmented rail being between the first corner joint and the third corner joint, the first linear joint comprising a lockable linear hinge comprising a fifth axis of rotation, the fifth axis of rotation being substantially aligned with an outer surface of the first segmented rail, wherein the first axis of rotation and the third axis of rotation are arranged such that the first segmented rail is substantially parallel to the first rigid rail and the second rigid rail when the collapsible device is in the collapsed position; and
a second segmented rail comprising a second linear joint, the second segmented rail being between the second corner joint and the fourth corner joint, the second linear joint comprising a second linear lockable hinge comprising a sixth axis of rotation, the sixth axis of rotation being substantially aligned with an outer surface of the second segmented rail, wherein the second axis of rotation and the fourth axis of rotation are arranged such that the second segmented rail collapses at an angle sufficient to prevent interference with the first segmented rail when the collapsible device is in the collapsed position;
a flexible material component configured to reversibly secure to at least a part of the collapsible device and provide the least partial containment; and
a foldable base configured to reversibly mate with the flexible material.

20. The collapsible device of claim 19, wherein none of the first axis of rotation, the second axis or rotation, the third axis of rotation, and the fourth axis of rotation are parallel to one another.

21. The collapsible device of claim 19, wherein the fifth axis of rotation and the sixth axis or rotation are substantially vertical and parallel with one another when the collapsible device is in the expanded position.

22. The collapsible device of claim 19, wherein the continuous rail is rectangular in shape with opposing first and second rigid rails and opposing first and second segment rails with the first and second segmented rails having a length that is longer than the first and second rigid rails.

23. The collapsible device of claim 19, wherein the second segmented rail includes a locking mechanism configured to be activated by a user and allow the user to lock and unlock the second linear joint.

24. The collapsible device of claim 19, further comprising a plurality of collapsible legs.

25. The collapsible device of claim 24, wherein each of the collapsible legs comprise:
a first end attached to the continuous rail;
a second end configured to rest upon a surface; and
a linear leg joint between the first end and the second end.

26. The collapsible device of claim 24, wherein the plurality of collapsible legs comprises four collapsible legs.

27. The collapsible device of claim 24, wherein one of the collapsible legs is attached to the first rigid rail or the second rigid rail.
